(19) United States
(12) Patent Application Publication
(10) Pub. No.: US 2014/0124570 A1
(43) Pub. Date: May 8, 2014

(54) SYSTEM AND METHOD FOR AUTHENTICATION, USAGE, MONITORING AND MANAGEMENT WITHIN A HEALTH CARE FACILITY

(71) Applicant: Michael Anderson Franklin, Toronto (CA)

(72) Inventor: Michael Anderson Franklin, Toronto (CA)

(21) Appl. No.: 13/261,664

(22) PCT Filed: Nov. 25, 2011
(86) PCT No.: PCT/IB2011/055293

§ 371 Date: Jan. 9, 2014

Related U.S. Application Data
(60) Provisional application No. 61/416,424, filed on Nov. 23, 2010.

(51) Int. Cl. G06Q 30/02

(52) U.S. Cl. CPC G06Q 30/0241
USPC 235/375

(57) ABSTRACT

The present invention relates to a system for personalized data collection in the field of physical training, wellness and fitness comprising at least mobile device to measure and monitor the quality of the movements, a wireless network and an interconnected set of RFID readers and tags placed strategically on equipment with data transmitted and stored using a custom RFID reader and interactions with users using developed applications for smart phones and tablets.

### BACKGROUND OF THE INVENTION

It is a common phenomenon in modern society that people miss out on physical exercise during their working routine, which often does not allow spending sufficient time for health, wellness and fitness.

The case for the invention is to provide an ecosystem which comprises of RFID readers, mobile devices, and a wireless transportation layers that will facilitate the monitoring of workouts that aims to simplify the monitoring and analysis of end users personal fitness.

### SUMMARY OF THE INVENTION

Embodiments of the present invention integrate a number of technologies to provide a holistic system to identify, monitor and track usage of radio frequency identification (RFID) tagged equipment. The tracking process encompasses a secured wireless network with identifiable RFID tags, e.g. placed upon objects and clothing, that manage to transmit data to a central repository for storage and analysis, wherein at least one RFID tag is attached to or embedded in an exercise instrument or medical equipment that can be used for physical exercise with the custom developed RFID reader embedded with a mobile device and device or separately and multitude application.

The data generated and contained is integrated within a multi-tiered CRM application to deliver multi-channel messaging that aims to improve the customers experience through the use of targeted advertising, informatics and by providing key indicators to users, staff and management within the scope of sales, service and marketing.

In one embodiment of the present invention the system for personalized data collection in the field of physical training, wellness and fitness comprises an mobile device and or tablet, a secure wireless network and an interrelated set of at least two RFID enabled devices, wherein at least one RFID enabled device is attached to the mobile device and at least a set of RFID tags are capable of receiving and transmitting the information set from at least one RFID tag to the custom mobile RFID reader.

The development of the process is specifically designed to attract new customers to health care facilities by delivering an interactive and accurate approach to physical fitness that facilitates self-enablement and promotes self care. The process can be scaled, leveraging existing infrastructures to manage transactional data and provide information to identified actors. The process is configurable on a open architecture to allow future innovations that can be embedded within the current infrastructure.

The present invention further relates to an integrated Health and Life Sciences solution used within a secure wireless mesh environment to automate the identification, storage and retrieval of physical fitness data using specially configured RFID tags and a custom reader, preferably integrated or attached to a mobile device. The mobile device will be responsible to transmit and gather fitness data from equipped instruments or fitness embedded with RFID tags. In that, the present invention utilizes RFID tags being accurately attached to or embedded in the mobile device to measure the quality of the performance of the physical exercise and mobile devices to collect data. Thereby, the RFID tag may be attached to or be embedded into the exercise instrument on any part or anywhere on the surface. In such a case the position of the moving tag can be followed by the RFID reader. By defining rules which motion the tag has to follow and which position the tag has to adopt to fulfill a successful exercise, it can be evaluated whether the performance of an exercising person was positive or negative. The business rules engine will contain rules to transmit to the mobile device using gyro, accelerometers and gravity sensors to track the quality of the movements against a repository.

Further, within the entire scope of this Health and Life Sciences solution multiple data stores are part of the overall design within a SOA to manage data from multiple sites containing various infrastructures. The scope of the data stores to be managed include: customer data mart, equipment data store, activity (operational) data mart, business rules data mart, activity completion rules, event triggers, advertising Data Mart, content management system, physics engine data mart to manage Soft Body dynamics, service, device management, metadata data mart, ad server, voice domain, rules engine, nutritional analytic engine, transactional data mart, RFID manager, reporting and analytics data mart.

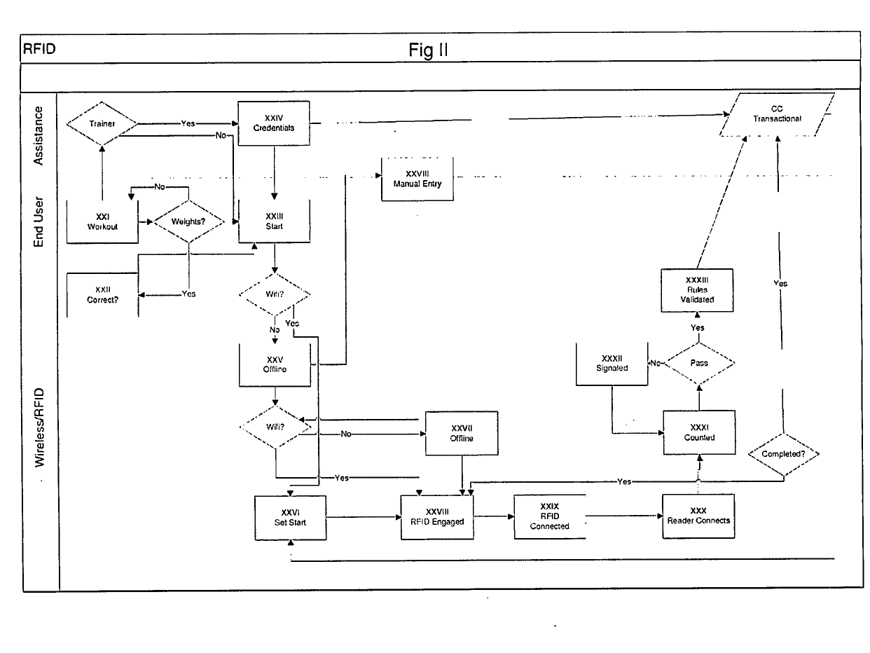

The physics engine data mart will maintain all calculations used to drive actions to calculate pass/failure actions of end users based on specific physical attributes (soft body dynamics) for over 24 personas. The exercises that cannot be measured based on the equipment attributes as part of the data mart. The attributes combined with the REID tags on e.g. the clothing of the user will drive. As part of the solution an accelerometer within the mobile device will measure changes in body movement to calculate the completion of an exercise. Embedded code from existing mobile applications will enable the feature with the events being driven based on specific actions. Sensor fusion will be used in conjunction with the movement calculations to determine the correct exercises. The sensor fusion combines both gyro data and accelerometer data will be used as a tilt and gravity sensor, while the gyroscope and its data will be used to measure dynamics (rotation). This particular aspect of the present invention is also depicted (FIG. 2). In combination, we expect calculations for workout completions to be accurate using this technology of the present invention. The compass will be used to calculate magnetic north. With all three, the system will be able to determine an accurate level of movement.

### BRIEF DESCRIPTION OF THE DRAWINGS

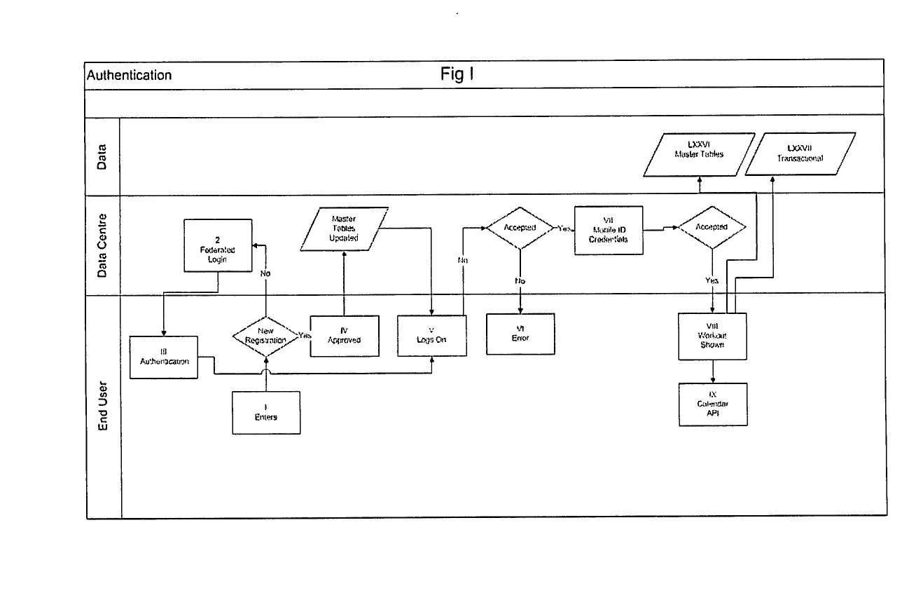

(FIG. 1) represents the authentication/workout engagement process flow that manages the device authentication and user authentication to use their mobile devices/tablets within the respected facility.

(FIG. 2) represents a sample workout engagement with the equipment and a trainer. The offline storage capabilities of the device and interactions within the wireless environment and RFID tagged equipment are shown.

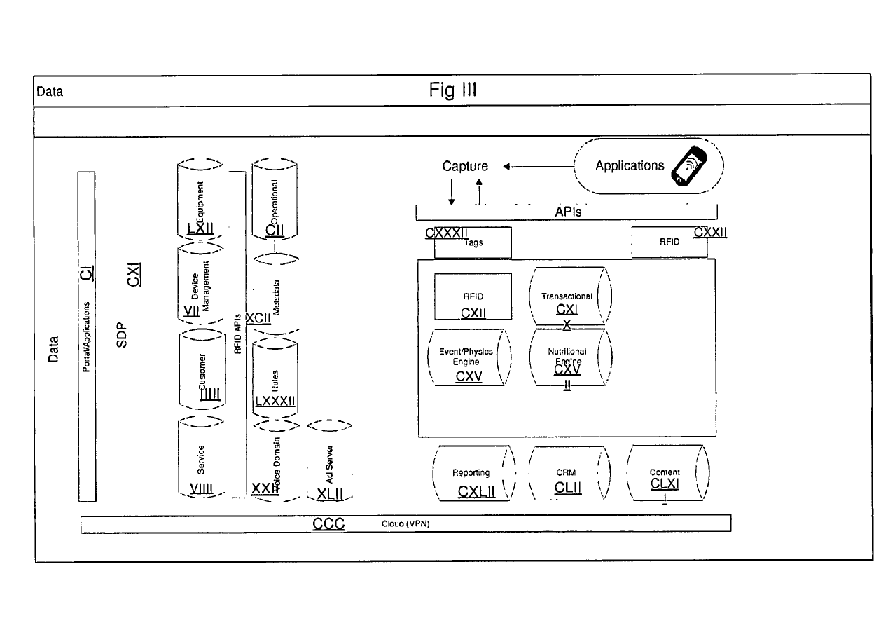

(FIG. 3) represents the data storage for the entire echosystem with data marts grouped by functionality.

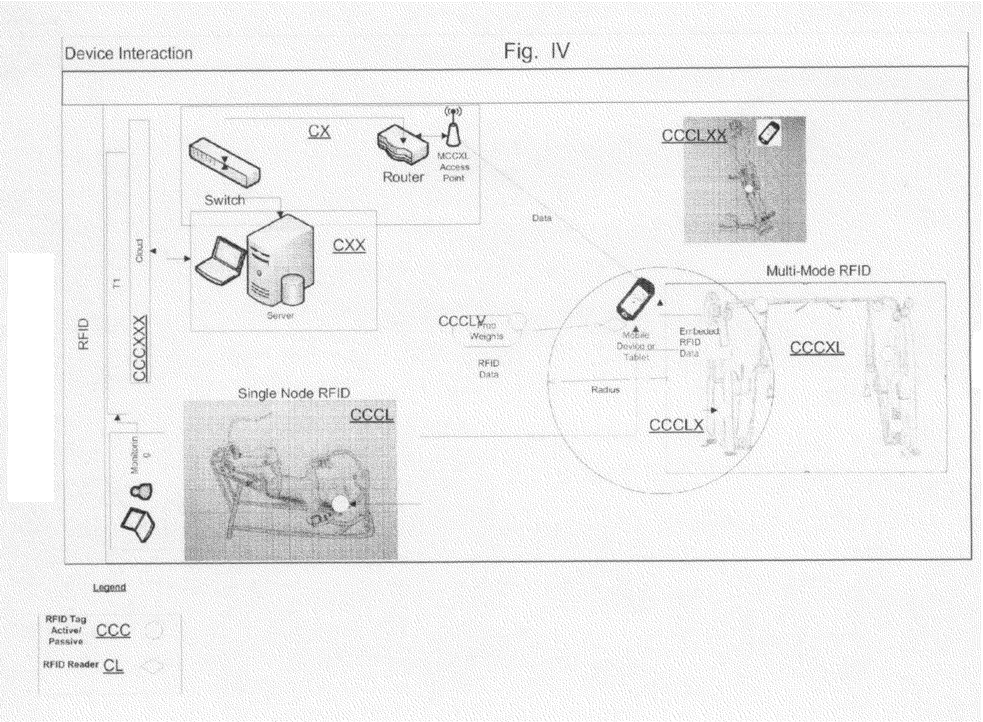

(FIG. 4) represents the sample communication process with multi-node and single-node RFID devices, the transmission and communication process.

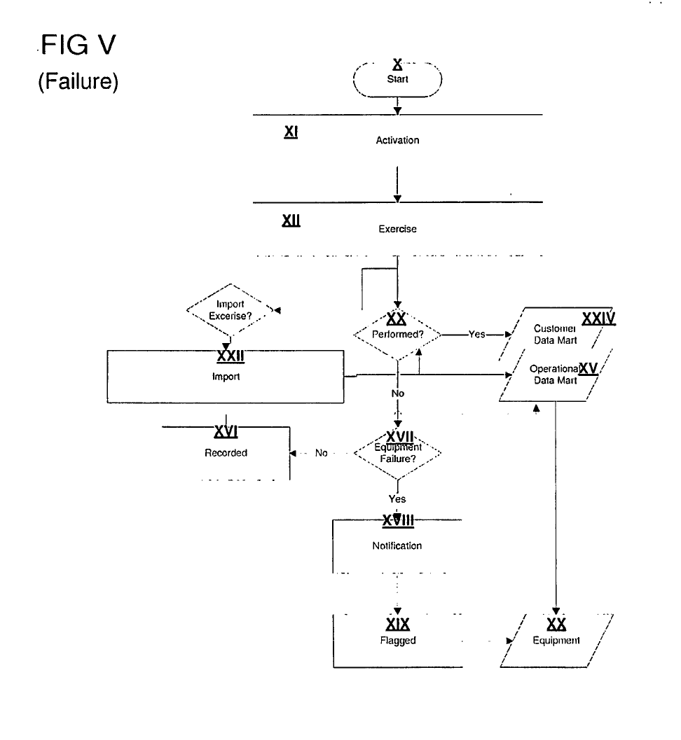

(FIG. 5) represents the failure process if the tags are not read properly, the mitigation process and the data stored.

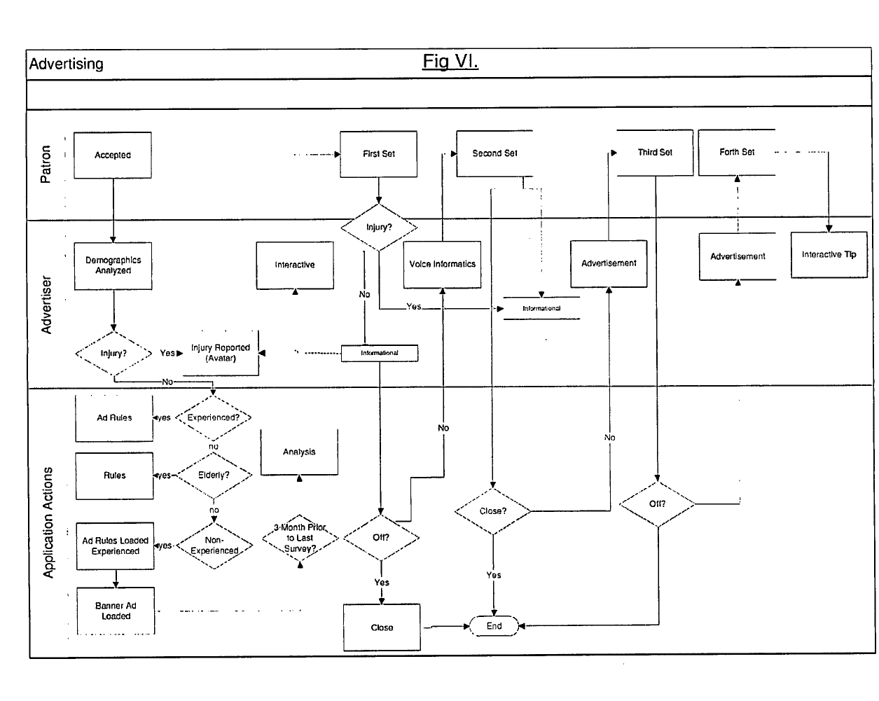

(FIG. 6) represents the proposed advertising model that is entirely event driven. The data stores are not included as part of the process. Localized advertisements are the primary action on the end users mobile device based on user driven events by their actions.

(FIG. 7) represents suitable exercises for the present invention but is not limited to the list as other will be added based on leveraging crowdsourcing.

### DETAILED DESCRIPTION OF THE INVENTION

The present invention includes a system for personalized data collection in the field of physical training, wellness and fitness comprising an interrelated set of at least two radio frequency identification (RFID) enabled devices, an exercise instrument and a secure wireless network. At least two RFID enabled devices (tag and reader) include at least one RFID transmitter and at least one RFID reader.

Physics will be utilized to measure the movement of the end user based on analysis of mobile device sensors. The mobile device sensors will consist of gyro data, accelerometer data as well as a tilt and gravity sensor. In addition, counts will be measured using the RFID tags placed upon resistance machines in the form of a weight to perform the corresponding exercise. In another embodiment of the present invention the RFID tag is attached to or embedded in a exercise machine. The position of the moving tag in the two afore-mentioned embodiments can be followed by the RFID reader and can be evaluated whether the tag was brought into the desired position. In another embodiment of the present invention an RFID tag is attached to or embedded in a movable part of the exercise equipment. Once the tag attached to the moveable part has reached a specific position, it will be considered accomplished and the customer has earned a count for the exercise.

Accordingly, the RFID tag on the moveable part of the exercise instrument has to be brought into a certain position by performing an exercise correctly. In case the RFID tag reaches the desired position, the reader will recognize it and the workout exercise is considered accomplished. The system can grant in such a case a count to the customer. Several accomplished exercises can then be comprehended to represent an accomplished workout routine.

The system of the present invention can be applied to any suitable exercise instrument, where a RFID reader can be embedded or at least attached to the smart phone. These suitable exercising instruments can also comprise medical instruments that are suitable to perform physical exercises. Such exercise instruments can include simple instruments such as a bar for pull ups, an exercising mat, but also very sophisticated, multifunctional exercise machines that allow a variety of exercises to be monitored from the same equipment. Exercising instruments according to the present invention can further comprise moveable exercising instruments such as a skid rope or a dumbbell. Suitable exercises that may be monitored by the system of the present invention comprise all possible and commonly performed exercises with or without equipment, preferably performed in a fitness or rehab facility. A subset of exercises include, alternating medicine ball press on Swiss ball, barbell bench press, barbell bench press speed, barbell board press, barbell pin press, burpees, cable crossovers, chest stretch, close-grip incline barbell press, decline barbell press, dumbbell bench press: speed, dumbbell chess press on Swiss ball, dumbbell chest press, dumbbell floor press, dumbbell flyes, flat bench dumbbell flyes, hindu pushup, incline barbell bench press, incline barbell press, incline dumbbell flyes, incline dumbbell press, incline dumbbell press, machine chest press, machine incline chest press, mechanical change pushup, chest press with medicine ball and rotation, standing chest pass with medicine ball, one-arm incline neutral dumbbell press, parallel-bar dips, pec deck flyes, plank to pushup, push ups with weight, pushup and row, pushup hold, pushups, close grip pushups, feet on Swiss ball pushups, hands on bench pushups, handstand pushups, kneeling pushups, medicine ball pushups, one-arm medicine ball pushups, plyometric pushups, rotation pushups, walking offset pushups, wide grip pushups, seated cable chest press, seated cable chest press, alternating seated cable press, seated cable press, single-arm split stance band press, spiderman pushup, split stance hand press, standing cable chest press, alternating arm standing cable chest press, alternating standing cable chest press, one-arm standing cable chest press, one arm single leg standing cable press, standing dumbbell flyes, stop-and-go pushup, Swiss ball pushup, alternating supine triceps extension. The above is a subset and can bet engaged with thousands of Others exercises are included that include equipment or without. Additional exercises will be added based on business rules that allow specific personas the ability to add new exercises.

The custom RFID readers will collect the information provided by the RFID tag/tags and are capable of further transmitting such data to an RFID managing unit via the mobile device or custom reader. In a preferred embodiment RFID readers are further capable of tracking more than one, rather several workout sessions simultaneously. An RFID reader can be placed anywhere in the fitness facility as long as the reader is able to communicate with the mobile device and preferably with the secure wireless network. Preferably, the RFID reader will have an operating range which the RFID reader can communicate with the RFID tags located within a predetermined operating radius, The RFID readers further communicate with the secure wireless network to transmit and receive personalize fitness data. The RFID reader is thereby integrated into an entire architecture comprising an VPN enabled secure wireless network enabling data transfer of the collected raw data and transmission to the RFID managing unit. In one embodiment the RFID reader may be embedded directly into the exercise instrument.

In a particularly preferred embodiment the RFID reader is custom developed and designed to be integrated with specific mobile devices, that when used with suitable applications, such as wireless data infrastructure along with a developed business process and physics engine, will be able to display, record and monitor workout routines, will indicate the quality of the exercise movement, all enable push/pull marketing capabilities. Such a custom developed RFID reader can be integrated in any suitable mobile device or tablet, preferably a smart phone. It can be configured and adapted to log and monitor entry and exit information within a health care facility serving as the basis for authorization, determining whether application usage privileges will be granted to a particular user and their RFID enabled device. In a preferred embodiment of the system of the present invention the RFID reader is capable of analyzing provided data comprising motion, acceleration and rotation. Therefore, tagging a customer with a custom developed RFID device capable of recognizing and analyzing motion, acceleration and rotation enables the system to monitor and analyze the customer's body motion during exercise, providing useful information about the manner of how a certain workout routine is performed.

The system according to the present invention comprises a wireless network. This network is configured to provide only authorized access, preferably by an encryption/decryption method to secure it against unauthorized access. Therefore, the present invention includes the development of a secure wireless network by incorporation of an authorization step, preferably VPN enabled, to facilitate data transfer and monitoring of the wireless network. A wireless network according to the present invention preferably includes an authorization step, e.g. by VPN encryption/decryption method, rendering it a secure wireless network. The RFID readers will utilize the secure wireless network to transmit the received raw data from the RFID tags. An RFID managing unit (RFID Manager) will act as the middleware that collects large volumes of raw data, filter them according to personalized exercise requirements and specific business rules.

The secure wireless network will also allow the interaction of a device management data store that will manage third party devices. The data store will contain master data for devices and be inherently linked to the majority of the data store within the architectures. In a further embodiment of the system according to the present invention the information retrieved from the exercising customer can be applied to specific and different analyzing tools. The architecture will follow a common service oriented architecture design.

The application layer will house the front facing applications (CI) that end users, management and the service delivery team will manage. The applications include security and network administration, tag management, content management system, CRM applications, and the applications used by end users as part of the solution.

The messaging store which is contained within the messaging layer (VIIII) will handle system and device logging, mobile access, remote network access and user authentication.

A service delivery platform (CXI) that will deliver network security management for the devices within the facilities. Business activities will also be monitored as part of this process.

Another aspect of the present invention is the use of RFID enabled devices for monitoring the quality and quantity of physical exercise, characterized in that at least one RFID tag is attached to an mobile device and an RFID reader collects the transmitted data for analysis. Such use comprises RFID tags placed by attachment or embedding on exercise instrument facilitates the tracking, monitoring and analyzing of exercising performance. In a preferred embodiment RFID enabled devices are used as being integrated into mobile devices, preferably RFID tags are used in mobile devices, more preferably RFID tags and RFID readers are used in mobile devices.

Further, another aspect of the present invention is an exercise instrument, wherein at least one RFID tag is attached to or embedded in the exercise instrument. As described above, different embodiments can be realized. One embodiment of an exercise instrument according to the present invention has at least one RFID tag attached to or embedded in a moveable part of the exercise instrument. Another embodiment of an exercise instrument according to the present invention the RFID tag attached to or embedded in a non-moveable part of the exercise instrument. In still another embodiment of an exercise instrument according to the present invention the tag is attached to or embedded in a moveable exercise instrument.

Still another aspect of the present invention is an exercise facility comprising a plurality of exercise instruments each having at least one RFID tag and at least one custom RFID reader able (Fig. IV) to communicate with at least a part of the plurality of RFID enabled devices on the exercising instruments.

The exercise facility could be any fitness center, gym, recreational areas in hospitals or health resorts. The term “exercise instruments” as used herein refers to cross trainers, multi gyms, treadmills, exercise bikes, benches, rowing machines, vibration plates, devices for weight lifting, racks, thwart, recumbent bikes and the like

The passive RFID tags will be enabled by the RFID reader based on predetermined ranges. When the end user performing the exercise, the communication process involves the RFID tag, RFID reader and connected mobile devices.

A flow chart (Fig. I) is depicted where at position (I) a customer enters the fitness facility. Depending on whether it is a new customer or not a registration procedure can be applied. In case a new customer enters the facility the system will be able to retrieve authentication data from e.g. a federated login (II), the customer is then provided with authentication details (III) and is ready to log on (V). In case the customer is already registered, e.g. with his phone as a custom developed RFID reader, the registration data is logged (IV) and the master tables will be updated. Once the logging is accepted a process of validation is run (VII) and the customer will be provided with a workout plan (8) on their device, which can be a mobile or tablet device, which can be pursued in the gym.

Therefore, as depicted in (Fig. II), the customer can then decide to take a personal trainer. Mobile tablets will be utilized and a process enabled for the trainer to view the data and input content. In any case the customer can start with the workout (XXIII) after choosing e.g. appropriate weights (XXII) or being provided with exercise details by the trainer (XXIV). According to the present invention the customer will log on and the beginning of a set starts in the online mode (XXV). The RFID reader is engaged (XXVIII) and will connect with one or several RFID tags (XXIX, XXX). In case these are passive RFID tags, these will be activated once the reader will be in close vicinity and these tags are selected from the system for this particular exercise. The customer will perform the exercises and the system will follow the performance by monitoring the moving of the tags, and movement quality using the mobile device physics or a custom developed RFID device and can decided whether a repetition counted or not. In case the exercise rules for the particular exercise are validated (XXXIII) the customer passes the exercise and the personalized data will be stored, analyzed and updated (CC). Also, the customer may be provided with an audio or video message on their smart phone/tablet summarizing the exercise performance. Even in case the exercises are performed offline (XXV, XXVII), for example, because the RFID reader cannot connect to the secure wireless network, the customer can start the predetermined exercise vs. offline data on their smart phone. The reader will follow the performance, save the data and will transmit it once the reader connects to the secure wireless network.

(Fig. III) illustrates the logical architecture and the various options to utilize to generated data by the system of the present invention. The management of the entire architecture will consist of multiple applications within a single portal (CI). Access to modules will be persona enabled. The architecture is comprised of a number of data stores which preferably can be managed within a third party (CCC) cloud infrastructure. The patentable schematics of the application include data stores specifically built to manage the data transfer of RFID information for the end user which is a key allocation for the service delivery platform (CXI). The architecture consists of a Consumer Data Mart (XXXII) that will manage all Personal Identifiable Information (PII) for end users, staff, management and other B2C or B2B PII data. Data will flow bi-operational to other data marts based on event triggered via business rules. The RFID data store will contain RFID related attributes issues and managed via a portal. The service module will be directly linked to the RFID Manager (CXII) and the equipment data store (LXII). Access rights will be managed within the device management data mart and used to ensure access rights for applications from the management portal (CI). The data mart will further contain customized taxonomy standards and attributes for all exercises (metadata, XCII) as well as the process for submission of new exercises using the RFID technology. The standards group mission will be developed to provide access to open, vendor-neutral, industry standard specifications and third party development tools that promote application and product development.

The platform will be developed to also integrate legacy systems. Third party payment platforms are the suggestion of choice. Payment processing is a considered a secondary function of the platform. A distributed crowd sourcing mechanism may also be developed permitting product makers and service providers to aggregate information regarding newly discovered exercises for their products Custom APIs will be developed that manage the customer data, transmit usage statics as well as integrate RFID data into a presentable form on a number of devices.

Further, a physics engine data mart (CXV) will maintain all calculations used to drive actions to calculate pass/failure actions of end users based on specific physical attributes (soft body dynamics) for over 24 personas. Also, the physics engine data mart is capable of calculating all different kinds of incoming information related to the tagged equipment or persona. Incoming information can be all data sent by the RFID tags or accelerometers within the mobile device measuring changes in body movement. Such information is used to calculate the completion of an exercise. For example, data about sensor fusion will be used in conjunction with the movement calculations to determine the correct exercises. The sensor fusion combines both gyro data and accelerometer data that will be used as a tilt and gravity sensor, while the gyroscope and its data will be used to measure dynamics (rotation).

These calculations depending on the result will then be used to deliver event driven, targeted advertising, informatics and analytics. The rules engine will enable demographic and multi-tiered advertising.

Specifically, an ad server may will be integrated to deliver targeted messages to manage advertising the advertising onto the devices within the workout environments. The tool processes may be linked to the advertising model that can be integrated as part of the total system. The business rules for the advertising to trigger advertising may be stored externally. The ad serving process may be interacted by event driven rules that are triggered by user actions (e.g. accomplishing a workout routine). These user actions may then trigger analytics and event driven advertising or information or both that, e.g. can be displayed to the user on a variety of platforms and spectrums.

(Fig. IV) Illustrated the hardware communication process. REID tagged equipment are shown in different embodiments. Such tagged equipment comprises instruments with one RFID tag on a moveable part (CCCLX), a tagged free weight (CCCLV) or a multifunctional exercise machine with several RFID tags on moveable part or on non-moveable parts (CCCLXX). Also, it may be possible that RFID tags are placed upon clothing and used in conjunction with the motion sensing capabilities of the smart devices to calculate movements for exercises considered out of scope for traditional exercises. Data generated during the exercise will be transmitted to the custom reader.

Once the mobile device has entered the proximity identification radius and has activated the corresponding tags on the respective equipment. The tags will be used to validate counts of exercises. The RFID reader will monitor specific transactions from exercise instruments equipped with RFID tags to transmit fitness routine data via the secure wireless network using for example an access point (MCCXL) with a router and a switch to a local server. Third party providers may be authorized to utilize such data using the third party cloud. Also, in a preferred embodiment multi-antenna readers are used to read tag data of multiple exercises from the same piece of equipment and from several participating customers. Therefore, the system is configured and adapted to independently identify and assign tags on exercise instruments to the corresponding customer enabling simultaneous use of the system for several exercising customers. Therefore, communications regarding the devices are able to communicate through multiple nodes. Further, WAN, Wifi Direct and Ultra High Frequency communications are the preferred protocols and frequencies used to deliver data from tags to readers and within the network. The schema at each location is expected to contain more than one reader at different locations. It is also expected that mechanisms will be in place to ensure that data is accepted by the correct reader with the specific variables.

In an example as illustrated in (FIG. 4) a customer can pursue an exercise on or with an exercise instrument for the workout routine personally chosen by the system. A count can then appear if e.g. a certain, single tag (e.g. CCCXL) is placed into a position that is calculated to indicate the exercise was completed correctly. Other variations include options to acquire a count if a tag, attached to a weight of an exercise instrument will pass a second tag attached to the exercise instrument at a certain position. The RFID readers, preferably a mobile device, will validate the accurate movements of the customer. Transactions are then either approved or denied through the placement of tags within the specific equipment and clothing. The data will be transmitted through the secure wireless network, preferably a VPN enabled wireless device, within the facility. RFID readers are provided with specific variables, from the physics engine that provide metrics for end user transactions to determine completion, partial completion or non-completion of exercises. The extent of completion or failure is depending on whether a count is accomplished or at least to which extent. Attributes regarding fitness routines independent of the extent of completion and thereby the success may be translated into voice commands and/or methods to display to the user. Widgets will be enabled to allow end users to view their data through common portals, e.g. the custom developed RFID reader, leveraging APIs that will enable data transmission of workout information, timelines and other health related data using federated logins.

Another embodiment of the present invention may provide a view on the functionality of the equipment and trigger service calls for malfunctioning sensors (Fig. V). The final application represented on this layer will be used by enterprise technology staff to manage the overall network, including data. Such feature is facilitated by the entire online character of the system of the present invention. As depicted in (Fig. V) a customer start by activating e.g. a mobile device with a preselected exercise set. After doing so, the question may arise whether the full exercise was performed In the affirmative case the system will recognize that immediately and will run the information through the corresponding data marts. If the full exercise was not performed it might be due to a failure of the equipment. As indicated at station point such an equipment failure can be considered and integrated into the system. Should the accomplishment of an exercise fail due to an instrument failure this information can tracked, identified and updated such that the customer is immediately able to be provided with clean and updated workout record.

A further advantage of the present invention is depicted in (FIG. 6) showing the advertising and informatics capabilities of the system according to the personal and specific needs of the customers. The system will leverage data from consumers to analyze the end user's physical health and e.g. end user demographics. This information can be used to deliver targeted advertising via different channels, including voice commands, SMS, or multimedia advertising. Also the demands of experienced users can be considered and the program can be adapted to their needs. The system is then configured to provide the customer with information according to their very specific demands depending on at which level they with their exercise.

(FIG. 5) depicts the equipment failure process and data import process. The invention leverages current technology to create a process to allow end users to import exercises from other end users or management with phones allowing direct transfer capabilities suing Wi-Fi direct or Bluetooth.

(FIG. 5) also depicts the same process to communicate RFID reading issues and the mitigation process. The migration process will be entering data manually for exercises where the communication process is interrupted.

1. A system for personalized data collection in the field of physical training, wellness and fitness comprising at least one exercise instrument, a wireless network and an interrelated set of at least two radio frequency identification (RFID) enabled devices, wherein at least one RFID enabled device is attached to the exercise instrument and at least a second RFID device is capable of receiving and transmitting the information set by the at least one RFID device attached to the exercise instrument.

2. The system according to claim 1, wherein the set of RFID enabled devices comprises RFID tags and RFID readers.

3. The system according to claim 2, wherein the RFID reader is integrated within an appliance.

4. The system according to claim 2 to 3, wherein the RFID reader further comprises at least one component selected from the group consisting of accelerometers, compasses and gyroscopes.

5. The system according to claims 2, wherein the RFID reader is integrated into mobile devices comprising tablets and smartphones.

6. The system according to claims 2, wherein the RFID reader is capable of analyzing motion, acceleration and rotation.

7. The system according to claims 2 to 6, wherein the RFID reader is capable of monitoring entry and exit information of a customer within a health care facility by logging into and out of the wireless network.

8. The system according to claims 2 to 7, wherein the RFID reader has a certain operating range within which the RFID reader can communicate with RFID tags located within that operating range.

9. The system according to claim 2, wherein the RFID tag is a passive RFID tag.

10. The system according to claim 1, wherein the interrelated set of at least two RFID enabled device further comprises an RFID tag being attached to a costumer.

11. The system according to claim 1, wherein the position of the each RFID enabled device during the workout will facilitate the generation of information whether an exercise was completed, part-completed or failed.

12. Use of RFID enabled devices for monitoring the quality and quantity of physical exercise, characterized in that at least one RFID tag is attached to an exercise instrument and an RFID reader collects the transmitted data for analysis.

13. Exercise instrument, wherein at least one RFID tag is attached to or embedded in the exercise instrument.

14. Exercise instrument according to claim 3, characterized in that it is a moveable exercise instrument.

15. Exercise instrument according to claim 3, wherein the RFID tag is attached to or embedded in a moveable part of the exercise instrument.

16. Exercise instrument according to claim 3, wherein the RFID tag is attached to or embedded in a non-moveable part.

17. Exercise facility comprising a plurality of exercise instruments each having at least one RFID enabled device thereon and at least one RFID reader able to communicate with at least a part of the plurality of RFID enabled devices on the exercising instruments.
